(19) United States
(12) Patent Application Publication
(10) Pub. No.: US 2024/0120140 A1
(43) Pub. Date: Apr. 11, 2024

(54) MULTILAYER COIL COMPONENT

(71) Applicant: TDK CORPORATION, Tokyo (JP)

(72) Inventors: Noriaki HAMACHI, Tokyo (JP); Toshinori MATSUURA, Tokyo (JP); Junichiro URABE, Tokyo (JP); Kota OIKAWA, Tokyo (JP); Yuto SHIGA, Tokyo (JP); Youichi KAZUTA, Tokyo (JP); Yuichi TAKUBO, Tokyo (JP); Shunya SUZUKI, Tokyo (JP); Xuran GUO, Tokyo (JP); So KOBAYASHI, Tokyo (JP)

(73) Assignee: TDK CORPORATION, Tokyo (JP)

(21) Appl. No.: 18/335,607

(22) Filed: Jun. 15, 2023

(30) Foreign Application Priority Data
Oct. 11, 2022 (JP) 2022-163307

(51) Int. Cl. H01F 17/00; H01F 27/29

(52) U.S. Cl. CPC H01F 17/0013; H01F 27/292; H01F 2017/002

(57) ABSTRACT

A plurality of through-hole conductors include a first through-hole conductor and a second through-hole conductor between coil conductors adjacent each other. Each of the first through-hole conductor and the second through-hole conductor includes a first end and a second end. The first end included in the second through-hole conductor is coupled to the second end included in the first through-hole conductor, and has a width larger than a width of the second end included in the first through-hole conductor. The first end included in the first through-hole conductor has a width larger than the width of the second end included in the first through-hole conductor. The second end included in the second through-hole conductor has a width smaller than the width of the first end included in the second through-hole conductor.

### CROSS-REFERENCE TO RELATED APPLICATIONS

This application is based upon and claims the benefit of priority from Japanese Patent Application No. 2022-163307, filed on Oct. 11, 2022. The entire contents of which are incorporated herein by reference.

### BACKGROUND

### Field

The present disclosure relates to a multilayer coil component.

### Description of the Related Art

Known multilayer coil components include an element body and a coil in the element body (see, for example, Japanese Unexamined Patent Publication No. 2013-153119). The coil includes a plurality of coil conductors and a through-hole conductor between coil conductors adjacent to each other of the plurality of coil conductors. The through-hole conductor electrically connects the coil conductors adjacent to each other.

### SUMMARY

One aspect of the present disclosure provides a multilayer coil component that prevents a decrease in connectivity between the coil conductors.

A multilayer coil component according to one aspect of the present disclosure includes an element body and a coil in the element body. The coil includes a plurality of coil conductor including a first coil conductor and a second coil conductor adjacent to each other, and a plurality of through-hole conductors electrically connecting the first coil conductor and the second coil conductor. The plurality of through-hole conductors a first through-hole conductor and a second through-hole conductor disposed in a direction in which the first coil conductor and the second coil conductor are adjacent to each other, between the first coil conductor and the second coil conductor. Each of the first through-hole conductor and the second through-hole conductor includes a first end and a second end. The first end is closer to the first coil conductor than the second end. The second end being closer to the second coil conductor than the first end. The first end included in the second through-hole conductor is coupled to the second end included in the first through-hole conductor, and has a width larger than a width of the second end included in the first through-hole conductor. The first end included in the first through-hole conductor has a width larger than the width of the second end included in the first through-hole conductor. The second end included in the second through-hole conductor has a width smaller than the width of the first end included in the second through-hole conductor.

In the one aspect described above, the first through-hole conductor and the second through-hole conductor electrically connect the first coil conductor and the second coil conductor. The first end included in the second through-hole conductor and the second end included in the first through-hole conductor are coupled to each other. The width of the first end included in the second through-hole conductor is larger than the width of the second end included in the first through-hole conductor. Therefore, even in a case where positional deviation occurs between the first through-hole conductor and the second through-hole conductor, the second end included in the first through-hole conductor tends to be located within a region of the first end included in the second through-hole conductor. The one aspect described above tends to reliably maintain an area of a region where the first through-hole conductor and the second through-hole conductor are coupled to each other. Consequently, the one aspect described above prevents a decrease in connectivity between the first coil conductor and the second coil conductor.

### BRIEF DESCRIPTION OF THE DRAWINGS

FIG. 1 is a perspective view illustrating a multilayer coil component according to an example;

FIG. 2 is an exploded view illustrating a configuration of the multilayer coil component according to the present example;

FIG. 3 is a view illustrating a cross-sectional configuration of the multilayer coil component according to the present example;

FIG. 4 is an exploded perspective view illustrating a configuration of coil conductors and through-hole conductors;

FIG. 5 is an exploded view illustrating a configuration of a multilayer coil component according to a modified example of the present example;

FIG. 6 is a view illustrating a cross-sectional configuration of the multilayer coil component according to the modified example of the present example;

FIG. 7 is an exploded perspective view illustrating a configuration of coil conductors, through-hole conductors, and a pad conductor; and

FIG. 8 is a plan view illustrating the pad conductor.

### DETAILED DESCRIPTION

In the following description, with reference to the drawings, the same reference numbers are assigned to the same components or to similar components having the same function, and overlapping description is omitted.

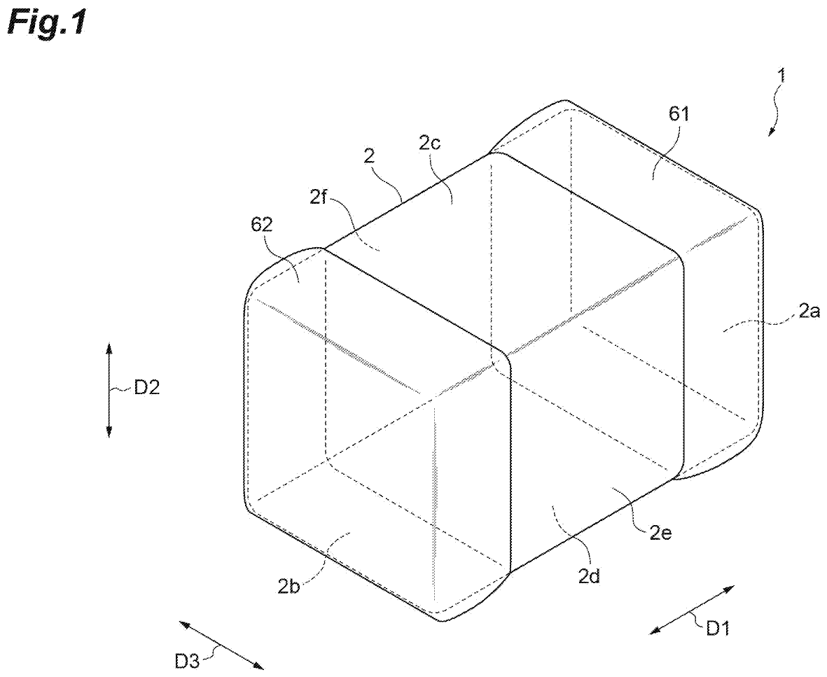

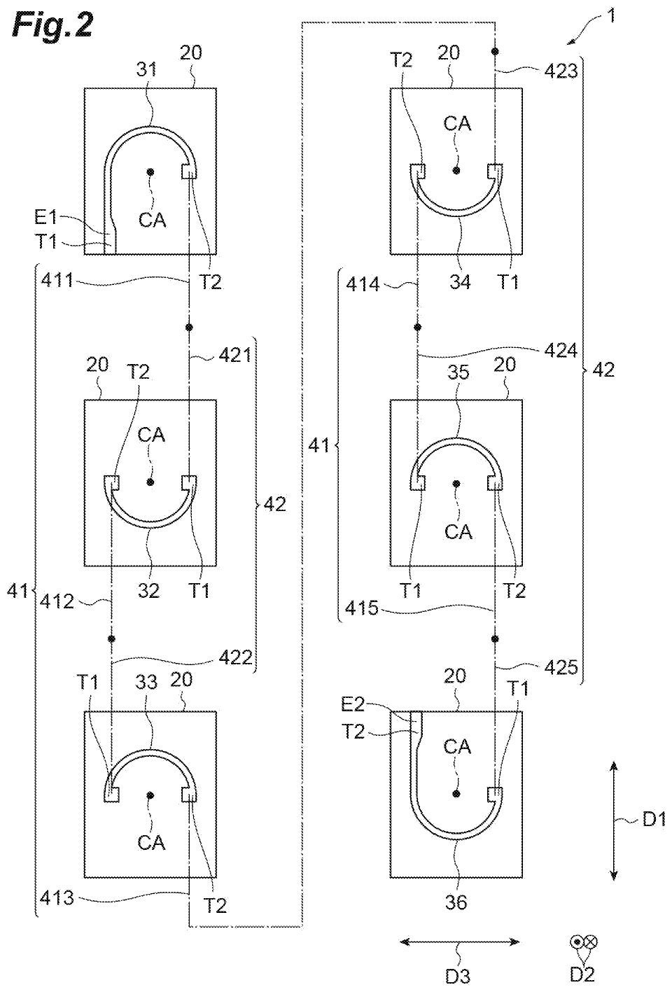

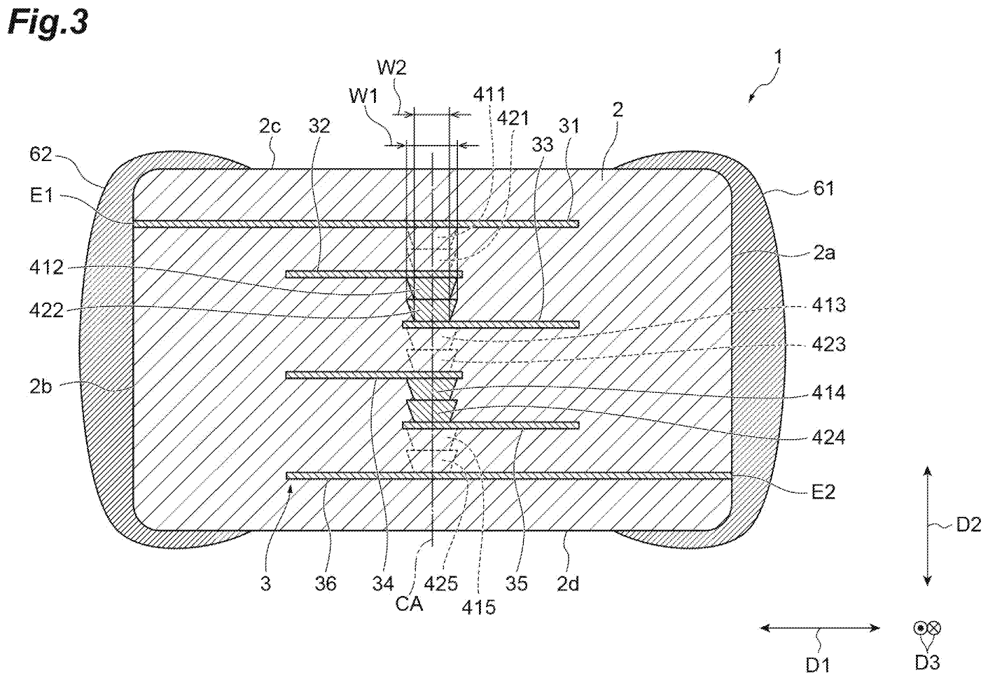

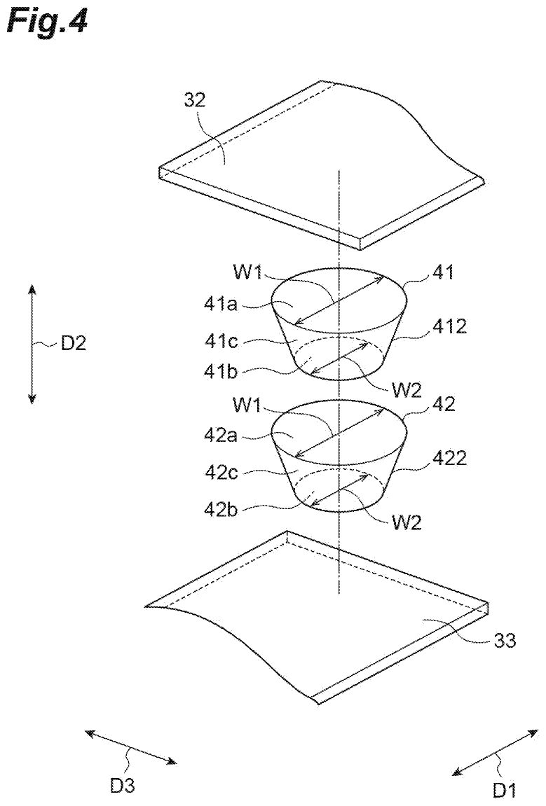

A configuration of the multilayer coil component 1 according to the present example will be described with reference to FIG. 1 to FIG. 4. FIG. 1 is a perspective view illustrating the multilayer coil component according to the present example. FIG. 2 is an exploded view illustrating a configuration of the multilayer coil component according to the present example. FIG. 3 is a view illustrating a cross-sectional configuration of the multilayer coil component according to the present example. FIG. 4 is an exploded perspective view illustrating a configuration of coil conductors and through-hole conductors. The multilayer coil component 1 is solder-mounted on an electronic device. The electronic device includes, for example, a circuit board or an electronic component.

As illustrated in FIG. 1 to FIG. 3, the multilayer coil component 1 includes an element body 2, a coil 3, and a pair of external electrodes 61 and 62. As illustrated in FIG. 3, the coil 3 is disposed in the element body 2. The element body 2 has a rectangular parallelepiped shape. The rectangular parallelepiped shape includes, for example, a rectangular parallelepiped shape in which corner portions and ridge portions are chamfered or a rectangular parallelepiped shape in which corner portions and ridge portions are rounded.

As illustrated in FIG. 1, the element body 2 includes a pair of end surfaces 2a and 2b opposing each other, and four side surfaces 2c, 2d, 2e, and 2f. In the present example, the pair of end surfaces 2a and 2b oppose each other in a direction D1, the side surfaces 2c and 2d oppose each other in a direction D2, and the side surfaces 2e and 2f oppose each other in a direction D3. An outer surface of the element body 2 includes the pair of end surfaces 2a and 2b and the four side surfaces 2c, 2d, 2e, and 2f. Each of the four side surfaces 2c, 2d, 2e, and 2f is adjacent to the pair of end surfaces 2a and 2b, and extends along the direction D1 to couple the end surface 2a and the end surface 2b. In the multilayer coil component 1 mounted on the electronic device, one of the four side surfaces 2c, 2d, 2e, and 2f opposes the electronic device. The one of the four side surfaces 2c, 2d, 2e, and 2f is arranged to constitute a mounting surface.

The direction D1 is orthogonal to the pair of end surfaces 2a and 2b. The direction D2 is orthogonal to the side surfaces 2c and 2d. The direction D3 is orthogonal to the side surfaces 2e and 2f. The direction D1 is orthogonal to the direction D2 and the direction D3. The direction D2 and the direction D3 are orthogonal to each other.

As illustrated in FIG. 2, the element body 2 includes a plurality of insulator layers 20. The element body 2 is formed through laminating the plurality of insulator layers 20. The plurality of insulator layers 20 are disposed in the direction D2. Each insulator layer 20 has a rectangular shape. The rectangular shape includes a shape in which corners are rounded or a shape in which corners are chamfered. The plurality of insulator layers 20 are integrated to such an extent that the boundaries between the insulator layers 20 cannot be visually recognized. In FIG. 2, illustration of each insulator layer 20 in which a plurality of through-hole conductors are located is omitted. FIG. 3 illustrates the element body 2 in which the plurality of insulator layers 20 are integrated.

Each insulator layer 20 includes, for example, a magnetic material. The magnetic material includes, for example, a Ni—Cu—Zn-based ferrite material, a Ni—Cu—Zn—Mg-based ferrite material, or a Ni—Cu-based ferrite material. The magnetic material may include an Fe alloy. Each insulator layer 20 may include a nonmagnetic material. The non-magnetic material includes, for example, a glass-ceramic material or a dielectric material. In the present example, each insulator layer 20 includes a sintered body of a green sheet containing the non-magnetic material.

The coil 3 includes a plurality of coil conductors 31, 32, 33, 34, 35, and 36, a plurality of through-hole conductors 41, and a plurality of through-hole conductors 42. The plurality of through-hole conductors 41 include a plurality of through-hole conductors 411, 412, 413, 414, and 415. The plurality of through-hole conductors 42 include a plurality of through-hole conductors 421, 422, 423, 424, and 425. The plurality of coil conductors 31 to 36 are disposed in the direction D2. The coil conductor 31 is closest to the side surface 2c among the coil conductors 31 to 36. The coil conductor 36 is closest to the side surface 2d among the coil conductors 31 to 36. The plurality of coil conductors 31 to 36 are disposed in the order of the coil conductor 31, the coil conductor 32, the coil conductor 33, the coil conductor 34, the coil conductor 35, and the coil conductor 36. The coil 3 includes an imaginary coil axis CA. The coil 3 is disposed in the element body 2 to have the coil axis CA. In the present example, the coil axis CA extends substantially along the direction D2, for example. The coil axis CA may extend substantially along the direction D3 or may extend substantially along the direction D1.

As illustrated in FIG. 3, the coil conductor 31 and the coil conductor 32 are adjacent to each other in the direction D2. The coil conductor 32 and the coil conductor 33 are adjacent to each other in the direction D2. The coil conductor 33 and the coil conductor 34 are adjacent to each other in the direction D2. The coil conductor 34 and the coil conductor 35 are adjacent to each other in the direction D2. The coil conductor 35 and the coil conductor 36 are adjacent to each other in the direction D2.

For example, at least one pair of the pair of coil conductors 31 and 32, the pair of coil conductors 32 and 33, the pair of coil conductors 34 and 35, or the pair of coil conductors 35 and 36 includes a first coil conductor and a second coil conductor. In the present example, each of the four pairs described above includes a first coil conductor and a second coil conductor. For example, when the coil conductor 31 includes a first coil conductor, the coil conductor 32 includes a second coil conductor. For example, when the coil conductor 32 includes a first coil conductor, the coil conductor 33 includes a second coil conductor. For example, when the coil conductor 33 includes a first coil conductor, the coil conductor 34 includes a second coil conductor. For example, when the coil conductor 34 includes a first coil conductor, the coil conductor 35 includes a second coil conductor. For example, when the coil conductor 35 includes a first coil conductor, the coil conductor 36 includes a second coil conductor.

For example, in each pair, the first coil conductor is closer to the side surface 2c than the second coil conductor, and the second coil conductor is closer to the side surface 2d than the first coil conductor.

Each of the coil conductors 31 to 36 includes a part of an annular path in the coil 3. Each of the coil conductors 31 to 36 has, for example, a shape in which a part of a loop is interrupted. Each of the coil conductors 31 to 36 includes a pair of ends T1 and T2. When viewed from the direction D2, in each of the coil conductors 31 to 36, each of the ends T1 and T2 has a width larger than a width of a portion other than the ends T1 and T2. Each of the coil conductors 31 to 36 extends between the end T1 and the end T2 along the annular path. The end T1 of the coil conductor 31 includes a conductor E1 exposed to the end surface 2b. The end T2 of the coil conductor 36 includes a conductor E2 exposed to the end surface 2a.

The plurality of through-hole conductors 411 and 421 are located between the pair of coil conductors 31 and 32 adjacent to each other. In the present example, the pair of through-hole conductors 411 and 421 are located between the pair of coil conductors 31 and 32. The pair of through-hole conductors 411 and 421 are disposed in the direction D2. The through-hole conductor 411 is closer to the coil conductor 31 than the through-hole conductor 421. The through-hole conductor 411 is physically and electrically connected to the end T2 of the coil conductor 31. The through-hole conductor 421 is closer to the coil conductor 32 than the through-hole conductor 411. The through-hole conductor 421 is physically and electrically connected to the end T1 of the coil conductor 32. In the present example, the pair of through-hole conductors 411 and 421 are physically and electrically connected to each other. The pair of through-hole conductors 411 and 421 electrically connect the pair of coil conductors 31 and 32.

The plurality of through-hole conductors 412 and 422 are located between the pair of coil conductors 32 and 33 adjacent to each other. In the present example, the pair of through-hole conductors 412 and 422 are located between the pair of coil conductors 32 and 33. The pair of through-hole conductors 412 and 422 are disposed in the direction D2. The through-hole conductor 412 is closer to the coil conductor 32 than the through-hole conductor 422. The through-hole conductor 412 is physically and electrically connected to the end T2 of the coil conductor 32. The through-hole conductor 422 is closer to the coil conductor 33 than the through-hole conductor 412. The through-hole conductor 422 is physically and electrically connected to the end T1 of the coil conductor 33. In the present example, the pair of through-hole conductors 412 and 422 are physically and electrically connected to each other. The pair of through-hole conductors 412 and 422 electrically connect the pair of coil conductors 32 and 33.

The plurality of through-hole conductors 413 and 423 are located between the pair of coil conductors 33 and 34 adjacent to each other. In the present example, the pair of through-hole conductors 413 and 423 are located between the pair of coil conductors 33 and 34. The pair of through-hole conductors 413 and 423 are disposed in the direction D2. The through-hole conductor 413 is closer to the coil conductor 33 than the through-hole conductor 423. The through-hole conductor 413 is physically and electrically connected to the end T2 of the coil conductor 33. The through-hole conductor 423 is closer to the coil conductor 34 than the through-hole conductor 413. The through-hole conductor 423 is physically and electrically connected to the end T1 of the coil conductor 34. In the present example, the pair of through-hole conductors 413 and 423 are physically and electrically connected to each other. The pair of through-hole conductors 413 and 423 electrically connect the pair of coil conductors 33 and 34.

The plurality of through-hole conductors 414 and 424 are located between the pair of coil conductors 34 and 35 adjacent to each other. In the present example, the pair of through-hole conductors 414 and 424 are located between the pair of coil conductors 34 and 35. The pair of through-hole conductors 414 and 424 are disposed in the direction D2. The through-hole conductor 414 is closer to the coil conductor 34 than the through-hole conductor 424. The through-hole conductor 414 is physically and electrically connected to the end T2 of the coil conductor 34. The through-hole conductor 424 is closer to the coil conductor 35 than the through-hole conductor 414. The through-hole conductor 424 is physically and electrically connected to the end T1 of the coil conductor 35. In the present example, the pair of through-hole conductors 414 and 424 are physically and electrically connected to each other. The pair of through-hole conductors 414 and 424 electrically connect the pair of coil conductors 34 and 35.

The plurality of through-hole conductors 415 and 425 are located between the pair of coil conductors 35 and 36 adjacent to each other. In the present example, the pair of through-hole conductors 415 and 425 are located between the pair of coil conductors 35 and 36. The pair of through-hole conductors 415 and 425 are disposed in the direction D2. The through-hole conductor 415 is closer to the coil conductor 35 than the through-hole conductor 425. The through-hole conductor 415 is physically and electrically connected to the end T2 of the coil conductor 35. The through-hole conductor 425 is closer to the coil conductor 36 than the through-hole conductor 415. The through-hole conductor 425 is physically and electrically connected to the end T1 of the coil conductor 36. In the present example, the pair of through-hole conductors 415 and 425 are physically and electrically connected to each other. The pair of through-hole conductors 415 and 425 electrically connect the pair of coil conductors 35 and 36.

For example, at least one of the pair of through-hole conductors 411 and 421, the pair of through-hole conductors 412 and 422, the pair of through-hole conductors 413 and 423, the pair of through-hole conductors 414 and 424, and the pair of through-hole conductors 415 and 425 includes a first through-hole conductor and a second through-hole conductor. In the present example, each of the five pairs described above includes a first through-hole conductor and a second through-hole conductor. Each through-hole conductor 41, that is, each of the through-hole conductor 411, 412, 413, 414, and 415 includes a first through-hole conductor, for example, and each through-hole conductor 42, that is, each of the through-hole conductor 421, 422, 423, 424, and 425 includes a second through-hole conductor, for example.

FIG. 4 illustrates a configuration in which the through-hole conductor 41 includes the through-hole conductor 412 and the through-hole conductor 42 includes the through-hole conductor 422. The pair of through-hole conductors 41 and 42 are located between the pair of coil conductors 32 and 33 adjacent to each other. The pair of through-hole conductors 41 and 42 are disposed in the direction D2. The through-hole conductor 41 is closer to the coil conductor 32 than the through-hole conductor 42, and the through-hole conductor 42 is closer to the coil conductor 33 than the through-hole conductor 41. In FIG. 4, illustration of each insulator layer 20 is omitted.

The through-hole conductor 41 includes a pair of ends 41a and 41b and a side surface 41c. The end 41a is closer to the coil conductor 32 than the end 41b. The end 41b is closer to the coil conductor 33 than the end 41a. The side surface 41c couples the end 41a and the end 41b. The end 41a and the end 41b oppose each other in the direction D2.

The through-hole conductor 42 includes a pair of ends 42a and 42b and a side surface 42c. The end 42a is closer to the coil conductor 32 than the end 42b. The end 42b is closer to the coil conductor 33 than the end 42a. The side surface 42c couples the end 42a and the end 42b. The end 42a and the end 42b oppose each other in the direction D2.

The end 41a is coupled to the coil conductor 32. The end 41a is directly coupled to the coil conductor 32. The end 41a is electrically and physically connected to the coil conductor 32. The end 41a and the coil conductor 32 may be integrated with each other. The end 42b is coupled to the coil conductor 33. The end 42b is directly coupled to the coil conductor 33. The end 42b is electrically and physically connected to the coil conductor 33. The end 42b and the coil conductor 33 may be integrated with each other. The end 42a is coupled to the end 41b. The end 42a is directly coupled to the end 41b. The end 42a is electrically and physically connected to the end 41b. The end 41b and the end 42a may be integrated with each other.

For example, when each of the ends 41a and 42a includes a first end, each of the ends 41b and 42b may include a second end. For example, when the end 41a includes a first end, the end 41b may include a second end, the end 42a may include a third end, and the end 42b may include a fourth end.

Each of the ends 41a and 42a has a width W1. Each of the ends 41b and 42b has a width W2. The width W1 is greater than the width W2. The width W1 of the end 41a and the width W1 of the end 42a may be equal to or different from each other. The width W2 of the end 41b and the widths W2 of the end 42b may be equal to or different from each other. Each of the side surfaces 41c and 42c is inclined with respect to the direction D2. Each of the side surfaces 41c and 42c includes an inclined surface.

For example, when viewed from one direction intersecting the direction D2, the width W1 of the end 41a is greater than the width W2 of the end 41b. A ratio (W2/W1) of the width W2 of the end 41b to the width W1 of the end 41a is smaller than 1 and equal to or greater than 0.80. This ratio (W2/W1) is, for example, 0.85. For example, when viewed from one direction intersecting the direction D2, the width W1 of the end 42a is greater than the width W2 of the end 42b. A ratio (W2/W1) of the width W2 of the end 42b to the width W1 of the end 42a is smaller than 1 and equal to or greater than 0.80. This ratio (W2/W1) is also 0.85, for example. A ratio (W2/W1) of the width W2 of the end 41b to the width W1 of the end 42a is smaller than 1 and equal to or greater than 0.80. This ratio (W2/W1) is also 0.85, for example. The one direction intersecting the direction D2 may include the direction D1 or the direction D3.

The end 41a has a first area. The end 41b has a second area. The end 42a has a third area. The end 42b has a fourth area. The first area is larger than the second area. The third area is larger than the fourth area. The first area and the third area may be equal or different. The second area and the fourth area may be equal same or different. When viewed in the direction D2, the entire end 41b overlaps the end 41a. When viewed in the direction D2, the entire end 42b overlaps the end 42a. In the present example, each of the ends 41a, 42a, 41b, and 42b has, for example, a substantially circular shape when viewed from the direction D2. In this case, each of the through-hole conductors 41 and 42 has a substantially truncated cone shape. When viewed from the direction D2, each of the ends 41a, 42a, 41b, and 42b may have a substantially polygonal shape. In this case, each of the through-hole conductors 41 and 42 has a substantially truncated pyramid shape.

The side surface 41c is adjacent to the end 41a and the end 41b. The side surface 42c is adjacent to the end 42a and the end 42b. The side surface 41c is inclined such that a width of the through hole conductor 41 in one direction intersecting the direction D2 decreases with increasing a distance from the coil conductor 32. When the through-hole conductor 41 is cut in a plane perpendicular to the direction D2, a cross-sectional area decreases with increasing a distance between from the coil conductor 32 to the plane. The side surface 42c is inclined such that a width of the through-hole conductor 42 in one direction intersecting the direction D2 decreases with increasing a distance from the coil conductor 32. When the through-hole conductor 42 is cut in a plane perpendicular to the direction D2, a cross-sectional area decreases with increasing a distance between from the coil conductor 32 to the plane.

The width W1 of the end 42a is larger than the width W2 of the end 41b. For example, when viewed from one direction intersecting the direction D2, the width W1 of the end 42a is larger than the width W2 of the end 41b. The one direction intersecting with direction D2 may include the direction D1 or the direction D3. The third area of the end 42a is larger than the second area of the end 41b. When viewed in the direction D2, the entire end 41b overlaps the end 42a. In the present example, as described above, the end 42a and the end 41b are directly coupled to each other.

In the present example, each of the through-hole conductors 411, 413, 414, 415, 421, 423, 424, and 425 is not illustrated. Like the through-hole conductors 412, each of the through-hole conductors 411, 413, 414, and 415 has the same shape as the through-hole conductor 41 illustrated in FIG. 4. Like the through-hole conductors 422, each of the through-hole conductor 421, 423, 424, and 425 has the same shape as the through-hole conductor 42 illustrated in FIG. 4.

As illustrated in FIGS. 1 and 3, the pair of external electrodes 61 and 62 are disposed at both ends of the element body 2 in the direction D1. The pair of external electrodes 61 and 62 are disposed on the element body 2 to oppose each other in the direction D1. The pair of external electrodes 61 and 62 are separated from each other in the direction D1.

The external electrode 61 includes an electrode portion located on the end surface 2a. The electrode portion of the external electrode 61 covers the conductor E2 exposed at the end surface 2a. The conductor E2 and the external electrode 61 are electrically connected to each other. The conductor E2 and the external electrode 61 are physically connected to each other. The conductor E2 electrically connects the coil 3 and the external electrode 61. The external electrode 62 includes an electrode portion located on the end surface 2b. The electrode portion of the external electrode 62 covers the conductor E1 exposed at the end surface 2b. The conductor E1 and the external electrode 62 are electrically connected to each other. The conductor E1 and the external electrode 62 are physically connected to each other. The conductor E1 electrically connects the coil 3 and the external electrode 62.

Each of the coil conductors 31 to 36 includes an electrically conductive material. Each of the coil conductors 31 to 36 includes an electrical conductor. The conductive material may include, for example, Ag, Pd, Cu, Al, or Ni. In the present example, each of the coil conductors 31 to 36 includes a sintered body of an electrically conductive paste including powders of the electrically conductive material. Each of the through-hole conductors 411 to 415 and 421 to 425 includes an electrically conductive material. Each of the through-hole conductors 411 to 415 and 421 to 425 includes an electrical conductor. The through-hole conductors 411 to 415 and 421 to 425 include, for example, the same material as that of the coil conductors 31 to 36. Each of the coil conductors 31 to 36 and each of the through-hole conductors 411 to 425 may include a plated conductor.

Each of the coil conductors 31 to 36 is formed between corresponding insulator layers 20 among the plurality of insulator layers 20, for example. Each of the through-hole conductors 411 to 415 and 421 to 425 is formed in a corresponding insulator layer 20 of the plurality of insulator layers 20. Each of the through-hole conductors 411 to 415 and 421 and 425 is formed in a through-hole formed in the corresponding insulator layer 20. The through hole formed in the corresponding insulator layer 20 is formed from, for example, a through hole formed in a green sheet for forming the corresponding insulator layer 20. The through hole formed in the insulator layer 20 includes a missing portion formed in the insulator layer 20. The through hole formed in the green sheet includes a missing portion formed in the green sheet. The shape of the through hole formed in the insulator layer 20 corresponds to the shape of the through hole formed in the green sheet. Laser processing is used to form the through hole in the green sheet. A width of the through-hole formed using laser processing decreases with increasing a distance from a surface irradiated with the laser. A process of forming the pair of through-hole conductors 41 and 42 may include, for example, preparing first and second green sheets, forming a first missing portion in the first green sheet, applying the electrically conductive paste into the first missing portion, forming a second missing portion in the second green sheet, applying the electrically conductive paste into the second missing portion, and laminating the first and second green sheets to which the conductive paste has been applied.

Each of the external electrodes 61 and 62 includes an electrically conductive material. Each of the external electrodes 61 and 62 includes an electrical conductor. The external electrodes 61 and 62 may include, for example, the same material as that of the coil conductors 31 to 36. Each of the external electrodes 61 and 62 may include a plated conductor.

As described above, in the multilayer coil component 1, the end 42a included in the through-hole conductor 42 and the end 41b included in the through-hole conductor 41 are coupled to each other. The width W1 of the end 42a included in the through-hole conductor 42 is larger than the width W2 of the end 41b included in the through-hole conductor 41. Therefore, even in a case where positional deviation occurs between the through-hole conductor 41 and the through-hole conductor 42, the end 41b included in the through-hole conductor 41 tends to be located within a region of the end 42a included in the through-hole conductor 42. The multilayer coil component 1 tends to reliably maintain an area of a region where the through-hole conductor 41 and the through-hole conductor 42 are coupled to each other. Consequently, the multilayer coil component 1 prevents a decrease in connectivity between the coil conductors 31 to 36.

In the multilayer coil component 1, the pair of through-hole conductors 41 and 42 are physically and electrically connected to each other. The end 42a included in the through-hole conductor 42 and the end 41b included in the through-hole conductor 41 are directly coupled to each other.

A region where the end 42a and the end 41b overlap each other in the direction D2 includes a region where the pair of through-hole conductors 41 and 42 are directly coupled to each other. The multilayer coil component 1 tends to reliably maintain the size of the region where the pair of through-hole conductors 4142 are directly coupled to each other. Therefore, the multilayer coil component 1 prevents a decrease in physical and electrical connectivity between the pair of through-hole conductors 41 and 42.

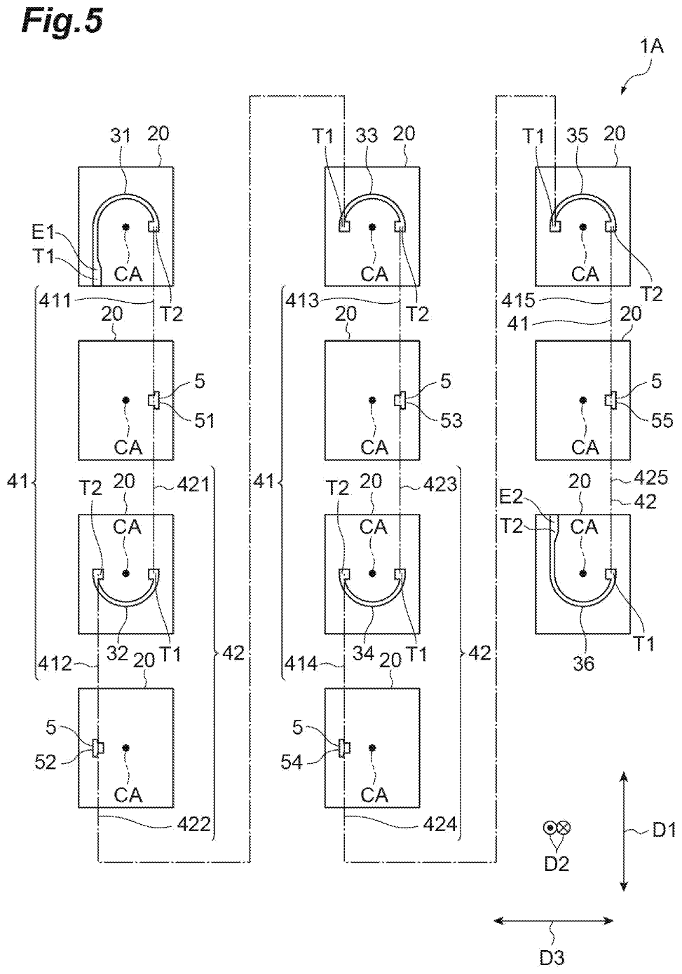

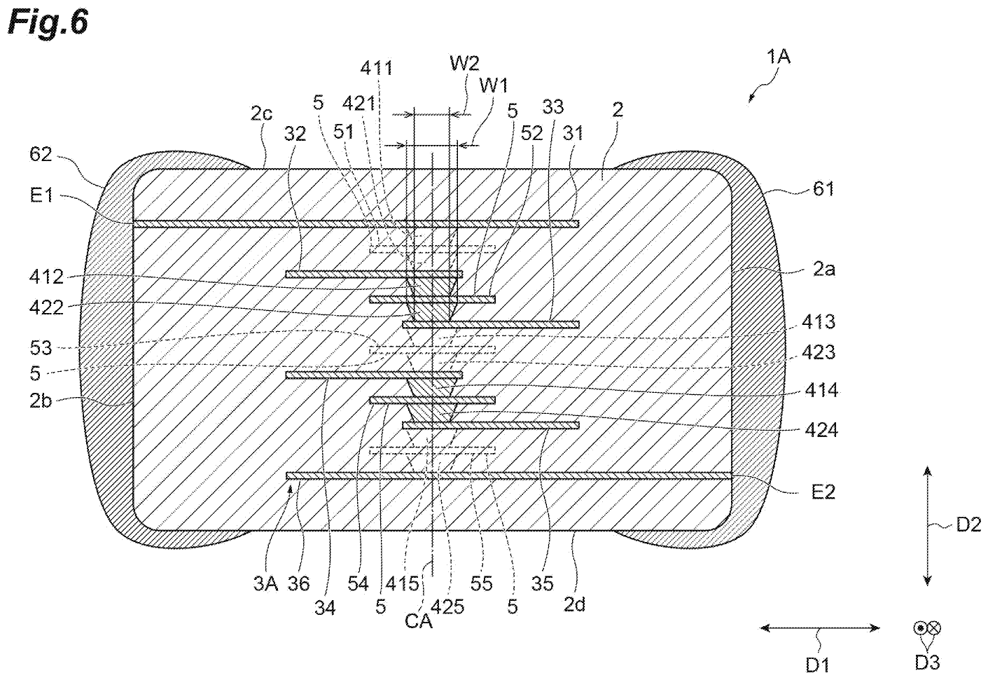

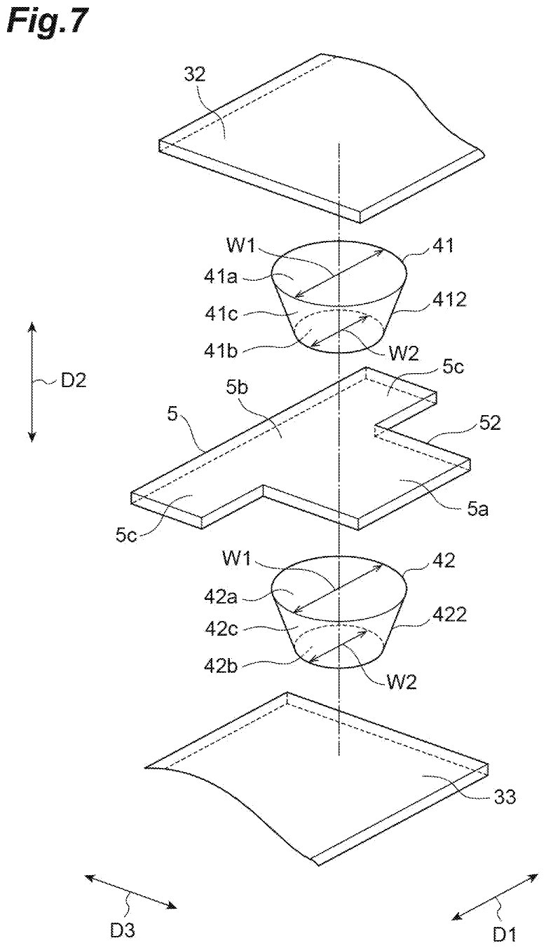

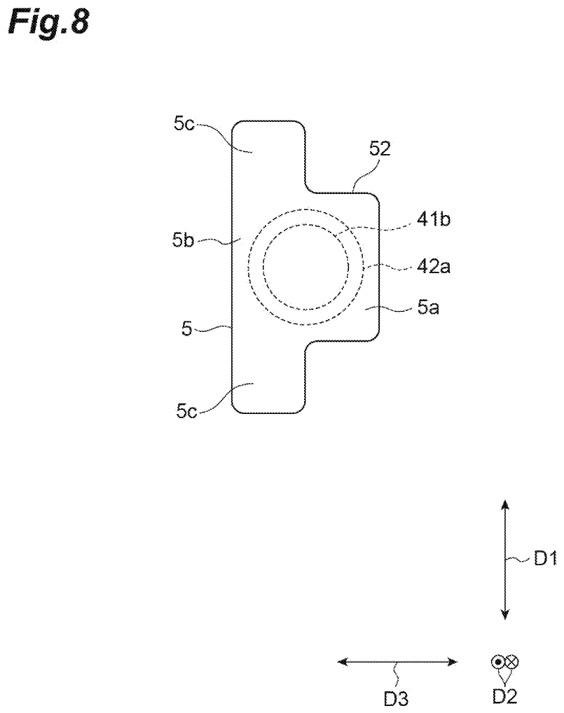

Next, a configuration of a multilayer coil component 1A according to a modified example of the present example will be described with reference to FIGS. 5 to 8. FIG. 5 is an exploded view illustrating a configuration of a multilayer coil component according to the present modified example. FIG. 6 is a view illustrating a cross-sectional configuration of the multilayer coil component according to the present modified example. FIG. 7 is an exploded perspective view illustrating a configuration of coil conductors, through-hole conductors, and a pad conductor. FIG. 8 is a plan view illustrating the pad conductor. The multilayer coil component 1A is generally similar to or the same as the multilayer coil component 1 described above. However, the multilayer coil component 1A is different from the multilayer coil component 1 in a configuration of the coil. Hereinafter, differences between the multilayer coil component 1A and the multilayer coil component 1 will be mainly described.

As illustrated in FIGS. 5 and 6, the multilayer coil component 1A includes the element body 2, a coil 3A, and the pair of external electrodes 61 and 62. The coil 3A is disposed in the element body 2. Like the coil 3, the coil 3A includes the imaginary coil axis CA. The coil 3A is disposed in the element body 2 to have the coil axis CA. The coil 3A includes the plurality of coil conductors 31, 32, 33, 34, 35, and 36, the plurality of through-hole conductors 41, and the plurality of through-hole conductors 42. The plurality of through-hole conductors 41 include the plurality of through-hole conductors 411, 412, 413, 414, and 415. The plurality of through-hole conductors 42 include the plurality of through-hole conductors 421, 422, 423, 424, and 425.

The end 42a included in the through-hole conductor 42 and the end 41b included in the through-hole conductor 41 may be indirectly coupled to each other. The coil 3A includes at least one pad conductor 5. As illustrated in FIGS. 5 and 7, the pad conductor 5 is located between the pair of through-hole conductors 41 and 42 adjacent to each other. The pair of through-hole conductors 41 and 42 are indirectly adjacent to each other in a state where the pad conductor 5 is located between the pair of through-hole conductors 41 and 42. The pad conductor 5 is coupled to the end 41b and the end 42a. The pad conductor 5 is directly coupled to the end 41b and the end 42a. The end 42a and the end 41b are indirectly coupled to each other via the pad conductor 5. The pad conductor 5 is physically and electrically connected to the through-hole conductor 41 and the through-hole conductor 42. The through-hole conductor 41 and the through-hole conductor 42 are electrically connected to each other through the pad conductor 5. In the present modified example, the coil 3A includes a plurality of pad conductors 5. The plurality of pad conductors 5 include a plurality of pad conductors 51, 52, 53, 54, and 55.

The pad conductor 51 is located between the pair of through-hole conductors 411 and 421 adjacent to each other. The pad conductor 51 is coupled to the end 41b included in the through-hole conductor 411 and the end 42a included in the through-hole conductor 421. The pad conductor 52 is located between the pair of through-hole conductors 412 and 422 adjacent to each other. The pad conductor 52 is coupled to the end 41b included in the through-hole conductor 412 and the end 42a included in the through-hole conductor 422. The pad conductor 53 is located between the pair of through-hole conductors 413 and 423 adjacent to each other. The pad conductor 53 is coupled to the end 41b included in the through-hole conductor 413 and the end 42a included in the through-hole conductor 423. The pad conductor 54 is located between the pair of through-hole conductors 414 and 424 adjacent to each other. The pad conductor 54 is coupled to the end 41b included in the through-hole conductor 414 and the end 42a included in the through-hole conductor 424. The pad conductor 55 is located between the pair of through-hole conductors 415 and 425 adjacent to each other. The pad conductor 55 is coupled to the end 41b included in the through-hole conductor 415 and the end 42a included in the through-hole conductor 425.

As illustrated in FIG. 8, the pad conductor 5 has, for example, a substantially T-shape when viewed from the direction D2. The pad conductor 5 may have a polygonal shape or a circular shape. As illustrated in FIG. 6, the pad conductor 5 has a width larger than the width W1 of the end 42a. For example, the width of the pad conductor 5 is larger than the width W1 of the end 42a and larger than the width W2 of the end 41b when viewed from one direction intersecting the direction D2. The one direction intersecting the direction D2 may include the direction D1 or the direction D3. When viewed from the direction D2, the entire end 41b overlaps with the pad conductor 5 and the entire end 42a overlaps with the pad conductor 5.

Each of the pad conductors 51 to 55 includes an electrically conductive material. Each of the pad conductors 51 to 55 includes an electrical conductor. The pad conductors 51 to 55 include, for example, the same material as that of the coil conductors 31 to 36. Each of the pad conductors 51 to 55 may include a plated conductor. Each of the pad conductors 51 to 55 is formed between corresponding insulator layers 20 among the plurality of insulator layers 20, for example.

As illustrated in FIGS. 7 and 8, in the present modified example, the pad conductor 5 includes a plurality of portions 5a and 5b. The portion 5a and the portion 5b are adjacent to each other. In present modified example, the portion 5a and the portion 5b are adjacent to each other in the direction D3, for example. When viewed from the direction D2, the portion 5a is closer to an inner side of the coil 3A than the portion 5b. When viewed from the direction D2, the portion 5b is closer to an outer side of the coil 3A than the portion 5a. The portion 5a is positioned to protrude from the portion 5b toward the inner side of the coil 3A. The portion 5b is positioned to protrude from the portion 5a toward the outer side of the coil 3A. The portion 5a and the portion 5b are continuous with each other. The portion 5a and the portion 5b are integrated with each other. The portion 5a is closer to the coil axis CA than the portion 5b. For example, when the portion 5a includes a first portion, the portion 5b may include a second portion.

In the present modified example, the portion 5b includes a plurality of portion 5c. The portion 5b includes, for example, a pair of portions 5c. Each portion 5c is positioned to extend along the direction D1. Each portion 5c extends to protrude from a region included in the portion 5b and corresponding to the portion 5a, for example, in the direction D1. The portion 5b has a width larger than a width of the portion 5a. Each width of the portions 5a and 5b includes a width in the direction D1, for example. The direction D1 includes a direction orthogonal to a direction in which the portion 5a and the portion 5b are adjacent to each other. The portion 5b including the plurality of portion 5c has an area larger than an area of the portion 5a.

As described above, the coil 3A includes the pad conductor 5. The pad conductor 5 is located between the through-hole conductor 41 and the through-hole conductor 42. The pad conductor 5 is coupled to the end 41b included in the through-hole conductor 41 and coupled to the end 42a included in the through-hole conductor 42. The width of the pad conductor 5 is larger than the width W1 of the end 42a of the through-hole conductor 42. Therefore, even in a case where positional deviation occurs between the through-hole conductor 42 and the pad conductor 5, the end 42a included in the through-hole conductor 42 tends to be located within a region of the pad conductor 5. Even in a case where positional deviation occurs between the through-hole conductor 41 and the pad conductor 5, the end 41b included in the through-hole conductor 41 tends to be located within the region of the pad conductor 5. The multilayer coil component 1A tends to reliably maintain an area of a region where the through-hole conductor 42 and the pad conductor 5 are connected to each other and an area of a region where the through-hole conductor 41 and the pad conductor 5 are connected to each other. Consequently, the multilayer coil component 1A further prevents a decrease in connectivity between the coil conductors 31 to 36.

The pad conductor 5 physically and electrically connects the through-hole conductor 41 and the through-hole conductor 42.

In the direction D2, a region where the pad conductor 5 and the end 42a overlap each other includes a region where the pad conductor 5 and the through-hole conductor 42 are directly coupled to each other. The multilayer coil component 1A tends to reliably maintain the size of the region where the pad conductor 5 and the through-hole conductor 42 are directly coupled to each other. The multilayer coil component 1A prevents a decrease in physical and electrical connectivity between the through-hole conductors 41 and 42.

The pad conductor 5 includes the portion 5a and the portion 5b adjacent to the portion 5a. The partial 5b is located on the outer side of the coil 3A than the portion 5a. In the direction D1, the width of the portion 5b is larger than the width of the partial 5a.

An area of an inner region of the coil affects an inductance value of the coil. As the area of the inner region of the coil decreases, the inductance value of the coil tends to decrease. The decrease in the inductance value of the coil tends to deteriorate electrical characteristics of the coil. In the configuration in which the pad conductor 5 includes a portion protruding toward the inner side of the coil 3A, when a size of the portion protruding toward the inner side of the coil 3A is large, the area of the inner region of the coil 3A decreases. In this case, characteristics of the multilayer coil component 1A may deteriorate. The characteristics of the multilayer coil component 1A include, for example, magnetic characteristics or electrical characteristics.

In the pad conductor 5, the portion 5a is smaller than the portion 5b. Therefore, the characteristics tends not to deteriorate in the multilayer coil component 1A.

The number of through-hole conductors located between two coil conductors adjacent to each other among the plurality of coil conductors 31 to 36 may be “3” or more. For example, the plurality of through-hole conductors located between two coil conductors adjacent to each other may include the through-hole conductor 41, the through-hole conductor 42, and another through-hole conductor. The through-hole conductor 41, the through-hole conductor 42, and the other through-hole conductor are disposed in the order of the through-hole conductor 41, the through-hole conductor 42, and the other through-hole conductor in the direction D2, for example. The through-hole conductor 42 is located between the through-hole conductor 41 and the other through-hole conductor. The other through-hole conductor includes a pair of ends opposing each other. One end included in the other through-hole conductor is coupled to the end 41b. Another end included in the other through-hole conductor is coupled to the end 42a. The one end included in the other through-hole conductor has a width larger than the width W2 of the end 41b. The other end included in the other through-hole conductor has a width smaller than the width W1 of the end 42a. The width W1 of the end 42a is larger than the other end included in the other through-hole conductor. The one end included in the other through-hole conductor has an area larger than the second area of the end 41b. The other end included in the other through-hole conductor has an area smaller than the third area of the end 42a. The third area of the end 42a is larger than the area of the other end included in the other through-hole conductor. For example, when the through-hole conductor 41 includes a first through-hole conductor, the other through-hole conductor may include a second through-hole conductor. For example, when the other through-hole conductor includes a first through-hole conductor, the through-hole conductor 42 may include a second through-hole conductor. The pad conductor 5 may be located between the through-hole conductor 41 and the other through-hole conductor. The pad conductor 5 may be located between the through-hole conductor 42 and the other through-hole conductor.

The pad conductor 5 may have a substantially trapezoidal shape when viewed from the direction D2. The pad conductor 5 having the substantially trapezoidal shape includes a pair of parallel sides and a pair of legs in a plan view. The pair of parallel sides includes a first side and a second side that is longer than the first side. For example, the pad conductor 5 may be disposed such that the first side is closer to the inner side of the coil 3A than the second side when viewed from the direction D2. The first side is closer to the coil axis CA than the second side.

In the present specification, in a case where an element is described as being coupled to another element, the element may be directly coupled to the other element or be indirectly coupled to the other element. In a case where an element is indirectly coupled to another element, an intervening element is present between the element and the other element. In a case where an element is directly coupled to another element, no intervening element is present between the element and the other element.

It is to be understood that not all aspects, advantages and features described herein may necessarily be achieved by, or included in, any one particular example. Indeed, having described and illustrated various examples herein, it should be apparent that other examples may be modified in arrangement and detail.

What is claimed is:

1. A multilayer coil component comprising:
an element body; and
a coil in the element body, wherein
the coil includes a plurality of coil conductor including a first coil conductor and a second coil conductor adjacent to each other, and a plurality of through-hole conductors electrically connecting the first coil conductor and the second coil conductor,
the plurality of through-hole conductors a first through-hole conductor and a second through-hole conductor disposed in a direction in which the first coil conductor and the second coil conductor are adjacent to each other, between the first coil conductor and the second coil conductor,
each of the first through-hole conductor and the second through-hole conductor includes a first end and a second end, the first end being closer to the first coil conductor than the second end, the second end being closer to the second coil conductor than the first end,
the first end included in the second through-hole conductor is coupled to the second end included in the first through-hole conductor, and has a width larger than a width of the second end included in the first through-hole conductor,
the first end included in the first through-hole conductor has a width larger than the width of the second end included in the first through-hole conductor, and
the second end included in the second through-hole conductor has a width smaller than the width of the first end included in the second through-hole conductor.

2. The multilayer coil component according to claim 1, wherein
the coil further includes a pad conductor between the first through-hole conductor and the second through-hole conductor, and
the pad conductor is coupled to the second end included in the first through-hole conductor and the first end included in the second through-hole conductor, and has a width larger than a width of the first end included in the second through-hole conductor.

3. The multilayer coil component according to claim 2, wherein
the pad conductor includes a first portion and a second portion adjacent to each other, and
the second portion has a width larger than a width of the first portion in a direction orthogonal to a direction in which the first portion and the second portion are adjacent to each other, and is closer to an outer side of the coil than the first portion.

4. The multilayer coil component according to claim 1, wherein
a ratio of the width of the second end included in the first through-hole conductor to the width of the first end included in the second through-hole conductor is smaller than 1 and equal to or greater than 0.80.

5. The multilayer coil component according to claim 1, wherein
a ratio of the width of the second end included in the first through-hole conductor to the width of the first end included in the first through-hole conductor is smaller than 1 and equal to or greater than 0.80.

6. The multilayer coil component according to claim 1, wherein
a ratio of the width of the second end included in the second through-hole conductor to the width of the first end included in the second through-hole conductor is smaller than 1 and equal to or greater than 0.80.

7. A multilayer coil component comprising:
an element body; and
a coil in the element body, wherein
the coil includes:
a first coil conductor;
a second coil conductor adjacent to the first coil conductor;
a first through-hole conductor including a first end and a second end opposing each other in a direction in which the first coil conductor and the second coil conductor oppose each other; and
a second through-hole conductor including a third end and a fourth end opposing each other in the direction in which the first coil conductor and the second coil conductor oppose each other,
the first through-hole conductor and the second through-hole conductor electrically connect the first coil conductor and the second coil conductor,
the first through-hole conductor is closer to the first coil conductor than the second through-hole conductor,
the first end is closer to the first coil conductor than the second end, and has a width larger than a width of the second end, and
the third end is couple to the second end, and has a width larger than the width of the second end and larger than a width of the fourth end.

8. The multilayer coil component according to claim 7, wherein
the coil further includes a pad conductor between the first through-hole conductor and the second through-hole conductor, and
the pad conductor is coupled to the second end and the third end, and has a width larger than the width of the third end.

9. The multilayer coil component according to claim 8, wherein
the coil is disposed in the element body to have a coil axis,
the pad conductor includes a first portion and a second portion adjacent to each other, and
the first portion has a width smaller than a width of the second portion in a direction orthogonal to a direction in which the first portion and the second portion are adjacent to each other, and is closer to the coil axis than the second portion.

10. The multilayer coil component according to claim 7, wherein
a ratio of the width of the second end to the width of the third end is smaller than 1 and equal to or greater than 0.80.

11. The multilayer coil component according to claim 7, wherein
a ratio of the width of the second end to the width of the first end is smaller than 1 and equal to or greater than 0.80.

12. The multilayer coil component according to claim 7, wherein
a ratio of the width of the fourth end to the width of the third end is smaller than 1 and equal to or greater than 0.80.

13. A multilayer coil component comprising:
an element body; and
a coil in the element body, wherein
the coil includes:
a first coil conductor;
a second coil conductor adjacent to the first coil conductor;
a first through-hole conductor including a first end and a second end opposing each other in a direction in which the first coil conductor and the second coil conductor oppose each other; and
a second through-hole conductor including a third end and a fourth end opposing each other in the direction in which the first coil conductor and the second coil conductor oppose each other,
the first through-hole conductor and the second through-hole conductor electrically connect the first coil conductor and the second coil conductor,
the first through-hole conductor is closer to the first coil conductor than the second through-hole conductor,
the first end is closer to the first coil conductor than the second end, and has an area larger than an area of the second end, and
the third end is couple to the second end, and has an area larger than the area of the second end and larger than an area of the fourth end.

14. The multilayer coil component according to claim 13, wherein
the coil further includes a pad conductor between the first through-hole conductor and the second through-hole conductor, and
the pad conductor is coupled to the second end and the third end, and has an area larger than the area of the third end.

15. The multilayer coil component according to claim 14, wherein
the coil is disposed in the element body to have a coil axis,
the pad conductor includes a first portion and a second portion adjacent to each other, and
the first portion has an area smaller than an area of the second portion, and is closer to the coil axis than the second portion.
